(19) United States
(12) Patent Application Publication
(10) Pub. No.: US 2026/0158889 A1
(43) Pub. Date: Jun. 11, 2026

(54) VEHICLE ROOF WITH MANUALLY CONFIGURABLE COVER

(71) Applicant: Ford Global Technologies, LLC, Dearborn, MI (US)

(72) Inventors: Michael John Harmon, Northville, MI (US); Robert J. Gelardi, Plymouth, MI (US)

(21) Appl. No.: 18/973,266

(22) Filed: Dec. 9, 2024

(51) Int. Cl. B60J 7/14

(52) U.S. Cl. CPC B60J 7/146

(57) ABSTRACT

A motor vehicle may include a roof including a roof opening. The motor vehicle may also include a cover including a first panel, a second panel foldable relative to the first panel between an open position and a closed position, and a connector. The connector may be configured to interface with a first attachment point to hold the second panel in the open position, and may be further configured to interface with a second attachment point to hold the second panel in the closed position.

### TECHNICAL FIELD

This disclosure relates to a motor vehicle including a roof with a manually configurable cover.

### BACKGROUND

Motor vehicles, including sport utility vehicles (SUVs), are known to include roofs that incorporate roof openings. These roof openings are configured be selectively uncovered, enabling passengers to enjoy the air and natural elements while maintaining the option for full coverage when needed.

### SUMMARY

In some aspects, the techniques described herein relate to a motor vehicle, including: a roof including a roof opening; and a cover including a first panel, a second panel foldable relative to the first panel between an open position and a closed position, and a connector, wherein the connector is configured to interface with a first attachment point to hold the second panel in the open position, and is further configured to interface with a second attachment point to hold the second panel in the closed position.

In some aspects, the techniques described herein relate to a motor vehicle, wherein the first attachment point is adjacent a first end of the roof opening and the second attachment point is adjacent a second end of the roof opening opposite the first end of the roof opening.

In some aspects, the techniques described herein relate to a motor vehicle, wherein the second attachment point is within an interior of the motor vehicle and the first attachment point is arranged on an exterior of the motor vehicle.

In some aspects, the techniques described herein relate to a motor vehicle, wherein: the connector includes a male component of a clasp, the first attachment point includes a female component of a clasp, and the second attachment point includes a female component of a clasp.

In some aspects, the techniques described herein relate to a motor vehicle, further including a strap configured to interface with the connector and to apply force to the first and second panels when the connector is interfaced with one of the first or second attachment points.

In some aspects, the techniques described herein relate to a motor vehicle, wherein the cover includes a third panel arranged between the first and second panels, wherein the third panel is foldable relative to the second panel and the first panel.

In some aspects, the techniques described herein relate to a motor vehicle, wherein the cover includes a fourth panel arranged between the first and third panels, wherein the fourth panel is foldable relative to the first, second, and third panels.

In some aspects, the techniques described herein relate to a motor vehicle, further including a strap configured to interface with the connector to apply force to the first, second, third, and fourth panels when the connector is interfaced with one of the first or second attachment points.

In some aspects, the techniques described herein relate to a motor vehicle, wherein, when the connector is interfaced with the second attachment point, the first, second, third, and fourth panels are arranged in an end-to-end arrangement and the strap is configured to apply a force to the cover.

In some aspects, the techniques described herein relate to a motor vehicle, wherein, when the connector is interfaced with the first attachment point, the first, second, third, and fourth panels are arranged in a stack and the strap is configured to apply a force to the stack.

In some aspects, the techniques described herein relate to a motor vehicle, wherein: the connector one of a plurality of connectors, the first attachment point is one of a plurality of first attachment points, and the second attachment point is one of a plurality of second attachment points.

In some aspects, the techniques described herein relate to a motor vehicle, wherein: each of the connectors is configured to interface with a corresponding one of the first attachment points and is further configured to interface with a corresponding one of the second attachment points.

In some aspects, the techniques described herein relate to a motor vehicle, further including a plurality of straps, wherein each of the plurality of straps is configured to interface with a corresponding one of the connectors.

In some aspects, the techniques described herein relate to a motor vehicle, wherein the first panel is rigidly mounted to the roof.

In some aspects, the techniques described herein relate to a motor vehicle, further including a seal extending about a perimeter of the roof opening, and wherein the second panel is in contact with the seal when the second panel is in the closed position.

In some aspects, the techniques described herein relate to a motor vehicle, wherein the first panel and the second panel are connected via a hinge assembly.

In some aspects, the techniques described herein relate to a cover for a motor vehicle, including: a first panel; a second panel foldable relative to the first panel between an open position and a closed position; and a connector, wherein the connector is configured to interface with a first attachment point to hold the second panel in the open position, and is further configured to interface with a second attachment point to hold the second panel in the closed position.

In some aspects, the techniques described herein relate to a cover, wherein: when the connector is interfaced with the second attachment point, the first and second panels are arranged in an end-to-end arrangement, and when the connector is interfaced with the first attachment point, the first and second panels are stacked.

In some aspects, the techniques described herein relate to a cover, further including a strap configured to interface with the connector and to apply force to the first and second panels when the connector is interfaced with one of the first or second attachment points.

In some aspects, the techniques described herein relate to a method, including: manually configuring a cover including first and second panels arranged relative to a roof opening of a motor vehicle such that a connector of the cover interfaces with a first attachment point to hold the second panel in an open position; and manually configuring the cover such that the connector interfaces with a second attachment point to hold the second panel in a closed position.

### BRIEF DESCRIPTION OF THE DRAWINGS

FIG. 1 illustrates a front perspective view of an example motor vehicle, which in this example is an SUV.

FIG. 2 is a top perspective view of a roof of the motor vehicle, with a cover fully covering a roof opening.

FIG. 3 is a view similar to FIG. 2, with the cover configured so as to at least partially uncover the roof opening.

FIG. 4 is a view, from an interior of the motor vehicle, of the cover in the position of FIG. 2.

FIG. 5 is a view of an example interface between a strap and a panel.

FIG. 6 is a view of a connector and an attachment point.

FIG. 7 is a view of the roof of the motor vehicle, with the cover transitioning between the positions of FIGS. 2 and 3.

FIG. 8 is a view of the roof of the motor vehicle, with the cover in the position of FIG. 3 and arranged relative to a roof rack.

### DETAILED DESCRIPTION

This disclosure relates to a motor vehicle including a roof with a manually configurable cover. Among other benefits, this disclosure allows a user to arrange the roof in a custom configuration to expose a desired portion of the passenger compartment to the elements. Further, the roof is configurable by hand, without the use of electrically powered equipment or tools.

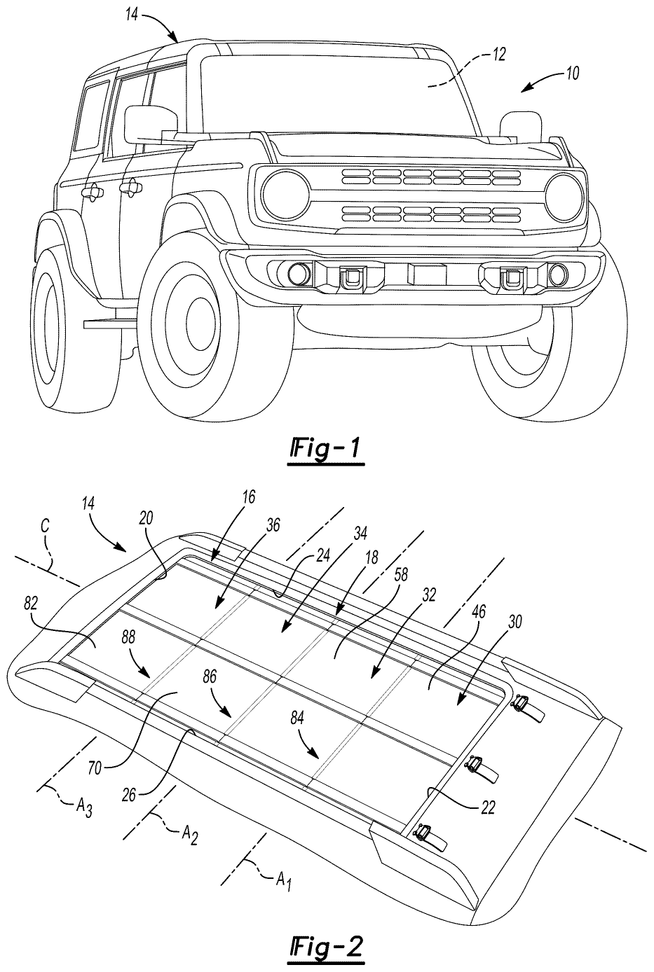

FIG. 1 illustrates a motor vehicle 10 (“vehicle 10”), which in this example is a sport utility vehicle (SUV). While an SUV is shown, the vehicle 10 could be another type of vehicle.

The vehicle 10 includes a passenger compartment, or passenger cabin, 12. A roof 14 is vertically above the passenger compartment 12. The roof 14 is defined by a body and/or a frame of the vehicle 10, and is generally configured to cover the passenger compartment 12 to protect the occupants from the weather and other elements.

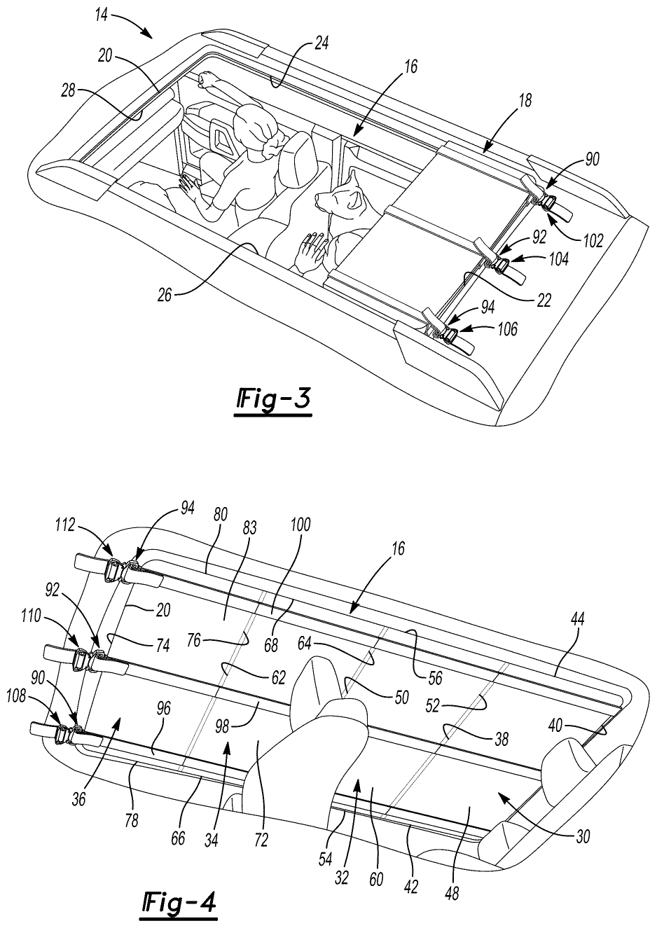

With reference to FIG. 2, the roof 14 includes a roof opening 16. The roof opening 16 is fully covered by a cover 18 in FIG. 2. In FIG. 3, the cover 18 is configured so as to uncover at least a portion of the roof opening 16. While the cover 18 is shown relative to a roof opening 16 herein, this disclosure extends to covers for other areas of the vehicle 10, and to covers for other areas of other types of vehicles, such as tonneau covers for pickup trucks.

The roof opening 16 is defined between a first end 20, a second end 22 opposite the first end 20, a first side 24 extending between the first and second ends 20, 22, and a second side 26 opposite the first side 24 and extending between the first and second ends 20, 22. The roof opening 16 is substantially rectangular in this example. The roof opening 16 exhibits an area within a range of 65-85% of the area of the roof 14 (inclusive of the roof opening 16). An elastomeric seal 28 (FIG. 3) may extend about the entire perimeter of the roof opening 16. When the cover 18 is configured as in FIG. 2, the cover 18 may be held in contact with the elastomeric seal 28 to resist ingress of water, dirt, etc., relative to the passenger compartment 12.

In this disclosure, the cover 18 includes at least a first panel, a second panel foldable relative to the first panel between an open position and a closed position, and a connector. The connector is configured to interface with a first attachment point to hold the second panel in the open position, and the connector is further configured to interface with a second attachment point to hold the second panel in the closed position.

In this example, the cover 18 includes a first panel 30, a second panel 32, a third panel 34, and a fourth panel 36. While the cover 18 includes four panels in this disclosure, the cover 18 could include a different number of panels. In FIGS. 2 and 4, the panels 30, 32, 34, and 36 are arranged in an end-to-end configuration in which the panels 30, 32, 34, 36 completely cover the entire roof opening 16. In FIGS. 2 and 4, the cover 18 is in a fully closed position. Further, in FIGS. 2 and 4, each of the panels 30, 32, 34, is in a closed position. In FIG. 3, the panels 30, 32, 34, 36 are configured into a vertically stacked configuration in which each of the panels 30, 32, 34, 36 are vertically stacked relative to one another. In the configuration of FIG. 3, the cover 18 is in an open position in which at least a portion of the roof opening 16 is uncovered by the cover 18. In FIG. 3, the panels 32, 34, 36 are in respective open positions.

In this disclosure, the cover 18 is manually configurable between the fully closed position of FIG. 2 and the open position of FIG. 3. In particular, in this example, at least the panels 32, 34, and 36 are manually configurable. Reference to the cover 18 and/or certain panels being manually configurable means the cover 18, and in turn the individual panels, is able to be configured between the fully closed and open positions without powered electrical components, such as motors, drives, actuators, etc., and further refers to the cover/panels being configurable by a user by hand and without the use of tools such as screwdrivers, drills, wrenches, etc.

In an aspect of this disclosure, the first panel 30 could be rigidly attached to the roof 14 using fasteners, for example, or may be integrally formed with the roof 14 (i.e., a portion of the roof 14 establishes the first panel 30), in some examples. While three manually configurable panels 32, 34, 36 are shown and described, this disclosure extends to embodiments with one or more manually configurable panels.

With reference to the orientation of the cover 18 in FIGS. 2 and 4, the panels 30, 32, 34, 36 will now be described. The first panel 30 includes a first end 38, a second end 40 opposite the first end 38, a first side 42 extending between the first and second ends 38, 40, and a second side 44 opposite the first side 42 and extending between the first and second ends 38, 40. The first panel 30 further includes an upper surface 46 and a lower surface 48. The first panel 30 is made of a rigid or semi-rigid material. The first panel 30 is configured to cover substantially 25% of the roof opening 16, in this example.

The second panel 32 includes a first end 50, a second end 52 opposite the first end 50, a first side 54 extending between the first and second ends 50, 52, and a second side 56 opposite the first side 54 and extending between the first and second ends 50, 52. The second panel 32 further includes an upper surface 58 and a lower surface 60. The second panel 32 is made of a rigid or semi-rigid material. The second panel 32 is configured to cover substantially 25% of the roof opening 16, in this example.

The third panel 34 includes a first end 62, a second end 64 opposite the first end 62, a first side 66 extending between the first and second ends 62, 64, and a second side 68 opposite the first side 66 and extending between the first and second ends 62, 64. The third panel 34 further includes an upper surface 70 and a lower surface 72. The third panel 34 is made of a rigid or semi-rigid material. The third panel 34 is configured to cover substantially 25% of the roof opening 16, in this example.

The fourth panel 36 includes a first end 74, a second end 76 opposite the first end 74, a first side 78 extending between the first and second ends 74, 76, and a second side 80 opposite the first side 78 and extending between the first and second ends 74, 76. The fourth panel 36 further includes an upper surface 82 and a lower surface 83. The fourth panel 36 is made of a rigid or semi-rigid material. The fourth panel 36 is configured to cover substantially 25% of the roof opening 16, in this example.

In the configuration of FIGS. 2 and 4, the panels 30, 32, 34, 36, together, fully cover the roof opening 16. The panels 30, 32, 34, 36 are arranged in an end-to-end arrangement. Further, the panels 30, 32, 34, 36 are connected together such that the panels 32, 34, 36 are foldable and such that the panels 30, 32, 34, 36 are configured to stack relative to one another, as shown in FIG. 3. In this disclosure, a first hinge assembly 84 (FIG. 2) connects the panel 30 to panel 32 adjacent ends 38 and 52. The first hinge assembly 84 is arranged along axis A1 and is configured to permit the panel 32 to rotate relative to panel 30 about axis A1 by up to substantially 180°. Axis A1 is substantially perpendicular to the centerline C of the vehicle 10.

A second hinge assembly 86 connects the panel 32 to panel 34 adjacent ends 50 and 64. The second hinge assembly 86 is arranged along axis A2 and is configured to permit the panel 34 to rotate relative to panel 32 about axis A2 by up to substantially 180°. Axis A2 is substantially perpendicular to the centerline C of the vehicle 10.

A third hinge assembly 88 connects the panel 34 to panel 36 adjacent ends 62 and 76. The third hinge assembly 88 is arranged along axis A3 and is configured to permit the panel 36 to rotate relative to panel 34 about axis A3 by up to substantially 180°. Axis A3 is substantially perpendicular to the centerline C of the vehicle 10.

The hinge assemblies 84, 86, 88 may be provided by assemblies configured to permit relative rotation of the panels 30, 32, 34, 36 about a corresponding one of the axes A1-A3. In an example, the hinge assemblies 84, 86, 88 may include, or be provided by, relatively flexible material, such as elastomeric material, connecting adjacent panels.

The cover 18 further includes at least one connector. In this example, the cover 18 includes three connectors 90, 92, 94 (FIGS. 3 and 4) arranged adjacent end 74 of panel 36. In particular, connectors 90, 92, 94 are rigidly connected to panel 36 adjacent end 74. Connector 90 is arranged adjacent side 78, connector 94 is arranged adjacent side 80, and connector 92 is laterally between connectors 90, 94. The connectors 90, 92, 94 are each provided by the male component of a buckle, in an example.

The cover 18 is configured to interface with straps 96, 98, 100, in this example. Connectors 90, 92, 94, in particular, are configured to interface with a corresponding one of the straps 96, 98, 100. Straps 96, 98, 100 are anchored, at one end, to a rigid portion of the vehicle 10 adjacent end 22 and to the connectors 90, 92, 94 at the other end. Straps 96, 98, 100 are configured to apply force to the panels 30, 32, 34 36 when the connectors 90, 92, 94 are interfaced with a corresponding attachment point. Straps 96, 98, 100 may wrap around panels 30, 32, 34, 36, such that a portion of each strap 96, 98, 100 runs along an upper surface of the cover 18 and a lower surface of the cover 18 (the terms “upper” and “lower” are used relative to the orientation of the cover 18 in FIGS. 2 and 4).

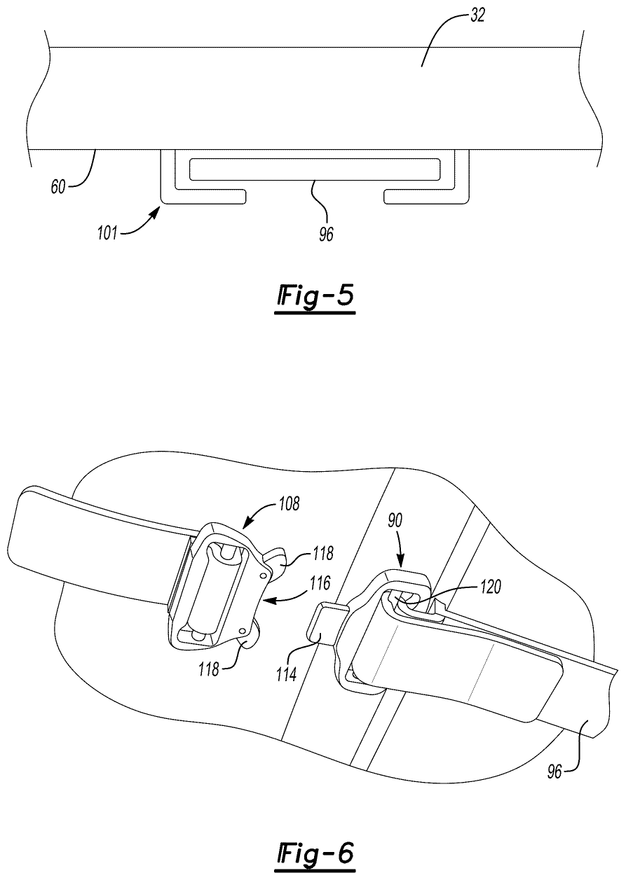

The straps 96, 98, 100 may be selectively detachable from at least some of the panels 30, 32, 34, 36. For example, as shown in FIG. 5, panel 32 may include a slotted channel 101 projecting from bottom surface 60 that can selectively capture the strap 96. The slotted channel 101 is open (i.e., it is slotted) and therefore the strap 96 can be selectively removed from the slotted channel 101. When captured by the slotted channel 101, the strap 96 is able to apply force to the panel 32. Panels 30, 32, 34 36 may include similar slotted channels receiving straps 96, 98, 100.

In this example, two sets of attachment points are rigidly mounted to the vehicle 10 and configured to selectively interface with the connectors 90, 92, 94. A first plurality of attachment points 102, 104, 106 (FIG. 3) are arranged adjacent end 22 of the roof opening 16, and a second plurality of attachment points 108, 110, 112 (FIG. 4) are arranged adjacent end 20 of the roof opening 16. Attachment points 102, 108 are laterally aligned with connector 90, attachment points 104, 110 are laterally aligned with connector 92, and attachment points 106, 112 are laterally aligned with connector 94. In this example, the first attachment points 102, 104, 106 are arranged on an exterior of the vehicle 10, namely attachment points 102, 104, 106 are rigidly mounted to an exterior of roof 14, and attachment points 108, 110, 112 are arranged on an interior of the vehicle 10, and in particular may be rigidly mounted adjacent a headliner of the vehicle 10.

Additional detail of the connector 90 and one of the second attachment points 108 will be described in FIG. 6. In this example, connector 90 includes male component 114 of a clasp or buckle. The male component 114 includes an insertion tab. The attachment point 108 includes a female component of a clasp or buckle. In particular, in this example, the second attachment point 108 includes a locking slot 116 configured to receive and hold the male component 114, and release arms 118 configured to permit selective removal of the male component 114.

In this example, connector 90 further includes a cinch mechanism including a bar or anchor point 120 configured to create friction to permit the strap 96 to wrap and thereabout and be tightened to apply a desired level of force onto the panels 30, 32, 34, 36.

The arrangement of connector 90 and attachment point 108 is representative of the arrangement of connectors 92, 94 and attachment points 102, 104, 106, 110, 112. Further, while a particular arrangement of the connector 90 and attachment point 108 has been shown, this disclosure extends to other arrangements.

In order to manually configure the cover 18 into the fully closed position, the panels 32, 34, 36 are folded relative to one another and relative to panel 30 such that the panels exhibit the end-to-end arrangement of FIGS. 2 and 4. Connectors 90, 92, 94 are connected to respective attachment points 108, 110, 112. Then, straps 96, 98, 100 are tightened to hold the cover 18 in place relative to the roof 14 and relative to the seal 28.

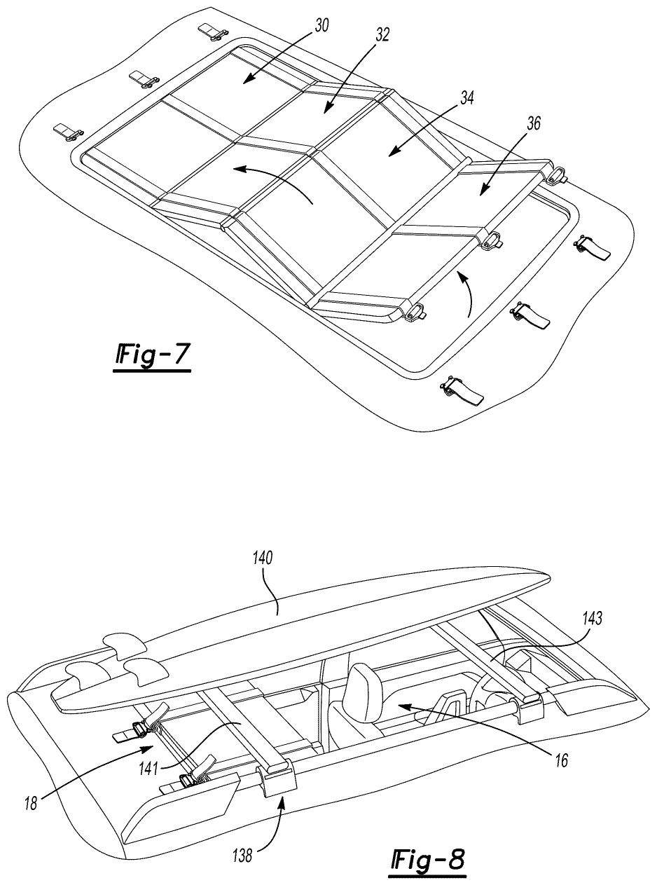

In order to manually configure the cover 18 from the fully closed position of FIGS. 2 and 4, the connectors 90, 92, 94 are detached from the attachment points 108, 110, 112. Then, with reference to FIG. 7 and with continued reference to FIGS. 2-6, panel 36 is rotated about axis A3 so as to bring surface 82 toward surface 70, panel 34 is rotated about axis A2 so as to bring surface 72 toward surface 60, and panel 32 is rotated about axis A1 so as to bring surface 58 toward surface 46. The result of this movement is that the panels 30, 32, 34, 36 are vertically stacked, as shown in FIG. 3, with panel 32 substantially vertically overlapping panel 30, panel 34 substantially vertically overlapping panel 32, and panel 36 substantially vertically overlapping panel 34. In this stacked configuration, connectors 90, 92, 94 are then connected to the attachment points 102, 104, 106 to hold the stack of panels in place. With the connectors 90, 92, 94 connected to attachment points 102, 104, 106, straps 96, 98, 100 may be tightened. Straps 96, 98, 100 may be detached from one or more of the panels 30, 32, 34, 36, such as by being removed from a corresponding slotted channel, such that the straps 96, 98, 100 are essentially wrapped around the stack of panels 30, 32, 34, 36. In another embodiment, the vehicle 10 may include additional straps configured to essentially wrap around the stacked panels 30, 32, 34, 36 and connected to the attachment points 102, 104, 106 via connectors to hold the panels 30, 32, 34, 36 in the stacked configuration of FIG. 3. Regardless, one or more straps are configured to apply a force to the stack of panels 30, 32, 34, 36.

Because of the relatively low profile of the panels 30, 32, 34, 36, the cover 18 can be held in the configuration of FIG. 3 without interfering with the functionality of a roof rack 138 (FIG. 8), even when the roof rack 138 includes cross-bars 141, 143 which may support gear 140, vertically overlapping the roof opening 16.

It should be understood that terms such as “about,” “substantially,” and “generally” are not intended to be boundaryless terms, and should be interpreted consistent with the way one skilled in the art would interpret those terms. Further, directional terms such as “upper,” “forward,” “rearward,” “upward,” “downward,” “vertical,” “horizontal,” “below,” “top,” “bottom,” etc., are used for purposes of explanation only and should not otherwise be construed as limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A motor vehicle, comprising:
a roof including a roof opening; and
a cover including a first panel, a second panel foldable relative to the first panel between an open position and a closed position, and a connector, wherein the connector is configured to interface with a first attachment point to hold the second panel in the open position, and is further configured to interface with a second attachment point to hold the second panel in the closed position.

2. The motor vehicle as recited in claim 1, wherein the first attachment point is adjacent a first end of the roof opening and the second attachment point is adjacent a second end of the roof opening opposite the first end of the roof opening.

3. The motor vehicle as recited in claim 2, wherein the second attachment point is within an interior of the motor vehicle and the first attachment point is arranged on an exterior of the motor vehicle.

4. The motor vehicle as recited in claim 1, wherein:
the connector includes a male component of a clasp,
the first attachment point includes a female component of a clasp, and
the second attachment point includes a female component of a clasp.

5. The motor vehicle as recited in claim 1, further comprising a strap configured to interface with the connector and to apply force to the first and second panels when the connector is interfaced with one of the first or second attachment points.

6. The motor vehicle as recited in claim 1, wherein the cover includes a third panel arranged between the first and second panels, wherein the third panel is foldable relative to the second panel and the first panel.

7. The motor vehicle as recited in claim 6, wherein the cover includes a fourth panel arranged between the first and third panels, wherein the fourth panel is foldable relative to the first, second, and third panels.

8. The motor vehicle as recited in claim 7, further comprising a strap configured to interface with the connector to apply force to the first, second, third, and fourth panels when the connector is interfaced with one of the first or second attachment points.

9. The motor vehicle as recited in claim 8, wherein, when the connector is interfaced with the second attachment point, the first, second, third, and fourth panels are arranged in an end-to-end arrangement and the strap is configured to apply a force to the cover.

10. The motor vehicle as recited in claim 8, wherein, when the connector is interfaced with the first attachment point, the first, second, third, and fourth panels are arranged in a stack and the strap is configured to apply a force to the stack.

11. The motor vehicle as recited in claim 1, wherein:
the connector one of a plurality of connectors,
the first attachment point is one of a plurality of first attachment points, and
the second attachment point is one of a plurality of second attachment points.

12. The motor vehicle as recited in claim 11, wherein:
each of the connectors is configured to interface with a corresponding one of the first attachment points and is further configured to interface with a corresponding one of the second attachment points.

13. The motor vehicle as recited in claim 12, further comprising a plurality of straps, wherein each of the plurality of straps is configured to interface with a corresponding one of the connectors.

14. The motor vehicle as recited in claim 1, wherein the first panel is rigidly mounted to the roof.

15. The motor vehicle as recited in claim 1, further comprising a seal extending about a perimeter of the roof opening, and wherein the second panel is in contact with the seal when the second panel is in the closed position.

16. The motor vehicle as recited in claim 1, wherein the first panel and the second panel are connected via a hinge assembly.

17. A cover for a motor vehicle, comprising:
a first panel;
a second panel foldable relative to the first panel between an open position and a closed position; and
a connector, wherein the connector is configured to interface with a first attachment point to hold the second panel in the open position, and is further configured to interface with a second attachment point to hold the second panel in the closed position.

18. The cover as recited in claim 17, wherein:
when the connector is interfaced with the second attachment point, the first and second panels are arranged in an end-to-end arrangement, and
when the connector is interfaced with the first attachment point, the first and second panels are stacked.

19. The cover as recited in claim 17, further comprising a strap configured to interface with the connector and to apply force to the first and second panels when the connector is interfaced with one of the first or second attachment points.

20. A method, comprising:
manually configuring a cover including first and second panels arranged relative to a roof opening of a motor vehicle such that a connector of the cover interfaces with a first attachment point to hold the second panel in an open position; and
manually configuring the cover such that the connector interfaces with a second attachment point to hold the second panel in a closed position.
